(19) United States
(12) Patent Application Publication
(10) Pub. No.: US 2017/0280220 A1
(43) Pub. Date: Sep. 28, 2017

(54) HEADWORN MICROPHONE SYSTEM WITH AN EARPIECE

(71) Applicant: DPA Miicrophones A/S, Allrød (DK)

(72) Inventors: Christian Poulsen, København K (DK); Anders Poulsen, Holte (DK)

(73) Assignee: DPA Miicrophones A/S, Allrød (DK)

(21) Appl. No.: 15/511,171

(22) PCT Filed: Sep. 15, 2015
(86) PCT No.: PCT/EP2015/071077

§ 371 Date: Mar. 14, 2017

(30) Foreign Application Priority Data
Sep. 15, 2014 (EP) 14184836.6

(51) Int. Cl. H04R 1/10; H04R 5/04; H04M 1/05; H04R 5/033

(52) U.S. Cl. CPC H04R 1/105; H04R 5/0335; H04R 5/04; H04R 1/1016; H04M 1/05; H04R 2201/107

(57) ABSTRACT

A microphone system including: an ear hook including a body member, a hook part and an output member; a microphone boom; a microphone connected to a first conductor and mounted on the microphone boom; a loudspeaker connected to a second conductor, wherein the microphone system is configured to feed an acoustic audio signal from the first loudspeaker via the output member; and an electrical connector for connecting the microphone system to an auxiliary device.

The present invention relates to a head worn microphone system comprising a miniature microphone, an earpiece, and a carrier comprising a boom and an ear hook for fixing the microphone and earpiece in place.

### BACKGROUND

Actors, TV hosts, performers or alike, want their voice to be recorded or amplified in high sound quality while seeking a microphone system which is as invisible as possible to not take away the focus of the viewer.

Further, actors, TV hosts, performers etc. wishes to be able to achieve audible cues and information while performing their act, e.g. a producer needs to pass on information of when to speak and when not to, what to say, where to look, information of changes etc.

Conventionally this is achieved by the performer being equipped with separate microphone and earpiece systems. The earpiece and the microphone systems are conventionally two separate devices attached to the performers head, and each attached to a separate transmitter unit out of sight, usually the transmitter units are affixed to the performers back.

Microphones need to maintain a very precise location in respect to the mouth of the performer, in order to attain and maintain a high quality sound recording. This may be achieved by affixing a microphone assembly to e.g. the ear that is in a fixed position in relation to the mouth. To ensure the best recording quality, it is further a demand that the microphone stays in the same position with respect to the mouth when the performer talks, twists his head, walks or in other ways moves around.

It is thus desirable to attain an assembly that is as invisible as possible. Further, it is an objective of the present invention that the mounting of the assembly on the user, be as easy as possible.

### SUMMARY

There is a need for a microphone system that combines advantages of a high end miniature microphone and an earpiece, and an assembly for affixing the microphone and earpiece in a comfortable, easy and precise way.

Accordingly, a microphone system is provided, the microphone system comprising: a first ear hook comprising a body member, a hook part and an output member, the output member being configured to be positioned in the ear canal of a user, the hook part having a first end and a second end with the first end attached to the body member and the second end attached to the output member, the hook part comprising a leaf spring for affixing the ear hook to a first ear of the user; a microphone boom having a first end and a second end, wherein the first end of the microphone boom is positioned below an ear of the user during use; a first microphone connected to a first conductor and mounted on the microphone boom for receiving a first acoustic audio signal and converting the first acoustic audio signal to a first electrical audio signal; a first loudspeaker connected to a second conductor for converting a second electrical audio signal into a second acoustic audio signal, wherein the microphone system is configured to feed the second acoustic audio signal from the first loudspeaker via the output member; and at least one electrical connector for connecting the microphone system to an auxiliary device, the at least one electrical connector including a first electrical connector comprising a first terminal connected to the first conductor and the at least one electrical connector comprising a second terminal connected to the second conductor.

It is an advantage of the present invention that the microphone system in one single assembly provides the users with a microphone which is precisely positioned and an earpiece that is disguised while providing a secure fit to the user.

The second terminal may be arranged in the first electrical connector.

The second terminal may be arranged in a second electrical connector.

The microphone system may comprise a first electrical cable with the first electrical connector arranged at a first end of the first electrical cable. The first electrical cable may comprise an insulating jacket and at least a part of the first conductor. The first electrical cable may have a length of at least 20 cm.

The microphone system may comprise a split electrical cable with the first electrical connector arranged at a first primary end of the split electrical cable and the second electrical connector arranged at a first secondary end of the split electrical cable. The split electrical cable may comprise an insulating jacket and at least a part of the first conductor and a part of the second conductor. The split electrical cable may have a length of at least 20 cm.

The first loudspeaker may be arranged in the output member.

The first loudspeaker may be arranged in the body member and the hook part comprising a tube for directing the acoustic output signal from the first loudspeaker to the ear of a user.

The microphone boom may comprise an electrical connector for connecting the first conductor to the first ear hook.

The microphone boom may be able to be twisted around a longitudinal axis of the microphone boom.

The microphone boom may be removably attached to the body member of the first ear hook.

The microphone system may comprise a second ear hook comprising a body member, and a hook part. The hook part of the second ear hook may comprise a leaf spring for attaching the second ear hook to a second ear of the user. The microphone system may comprise a neck assembly with the first and the second ear hook mounted on the neck assembly.

The microphone boom may be removably attached to the body member of the second ear hook.

The second ear hook may comprise an output member, and the microphone system may comprise a second loudspeaker connected to a third conductor for converting a third electrical audio signal into a third acoustic audio signal, wherein the microphone system may be configured to feed the third acoustic audio signal from the second loudspeaker via the output member of the second ear hook.

The first ear hook may comprise the first electrical connector.

The second ear hook may comprise the first electrical connector.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 illustrates an exemplary microphone system,

FIG. 2 is left out intentionally,

FIG. 3 schematically illustrates a cross section of an exemplary ear hook with an earpiece,

FIG. 4 schematically illustrates a cross section of an exemplary ear hook with an acoustic tube,

FIG. 5 illustrates an exemplary microphone system with two ear hooks,

FIG. 6 illustrates an exemplary microphone system with a first ear hook and a second ear hook, and

FIG. 7 illustrates an exemplary microphone system with two earpieces.

The figures are schematic and simplified for clarity, and they merely show details which are essential to the understanding of the invention, while other details have been left out. Throughout, the same reference numerals are used for identical or corresponding parts.

### DETAILED DESCRIPTION

Disclosed herein is a microphone system. The microphone system may comprise one or more ear hooks including a first ear hook, the ear hook(s) designed for attaching the microphone system to an ear of a user. An ear hook, such as the first ear hook and/or a second ear hook, may comprise a body member, a hook part and optionally an output member. The hook part may have a first end and a second end with the first end attached to the body member and the second end attached to the output member if present. The hook part may be configured to extend at least partly behind the pinna of the user's ear. The hook part may comprise flexible features, such as an elastomer and/or a spring element, for affixing the ear hook in question to an ear of a user. The spring element may be a leaf spring, which possess flexibility in a plane and rigidity perpendicular to the plane.

In the remains of the text, the ear hook will be described in the sense of utilizing a leaf spring. However, as mentioned, this could be other flexible items having similar beneficial properties.

The output member may be placed in an ear canal of the user.

The first and/or second ear hook is in part made of a flexible structure, the hook part, which is designed to fit around an ear of a user. The first and/or second ear hook may be cast such that the body member is designed to make contact with the bottom back part of the ear, while the hook part, being flexible, may extend around the back of the pinna of the ear to the top of the pinna of the ear.

Ear sizes are quite different between people. By using a flexible material the first and/or second ear hook may comfortable fit a large majority of people.

The leaf spring comprised within the hook part of the first and/or second ear hook, provides the first and/or second ear hook to suit a large number of people, regardless of ear size. Also the leaf spring comprised within the hook part provides, in combination with the body member, the ear hook to maintain a secure fit and maintaining its position relative to the mouth of the user, regardless of any head movement.

The ear hook may be adapted such that, when worn by a user, the body member abuts an outer surface of the pinna. The body member may be configured to abut an outer surface of the pinna below the ear canal and/or below the antitragus, e.g. near the temporomandibular joint. The ear hook may be adapted to extend at least partly behind the ear of a user during use.

The challenge when producing the ear hook is to find the right balance of flexibility for the hook part. If the hook part is too rigid, e.g. if the leaf spring is too tight, the microphone system may be uncomfortable to wear. On the other hand if the hook part is too flexible, e.g. if the leaf spring is too weak, the microphone system may not be securely fastened and may not maintain its initial position.

In order to fit different ear sizes, the hook part may have a length from the first end to the second end less than 10 cm, such as in the range of 2-10 cm, or in the range of 3-8 cm, or in the range of 4-7 cm. The thickness of the hook part may be in the range of 0.5-5 mm, or in the range of 1-4 mm or in the range of 2-3 mm.

An exemplary microphone system may comprise two ear hooks, where the two ear hooks are interconnected. Employing two ear hooks allow affixing the microphone system to both ears of the user, which establish an even more secure fit. Using a two ear version of the microphone system could be beneficial if the user is ought to wear the microphone system for a longer period, e.g. during a live TV transmission or if the user is moving around a lot, e.g. an actor performing a dance or alike.

The microphone system may comprise a microphone boom having a first end and a second end. The microphone boom may be attached to the body member of the first or second ear hook or to a microphone connector on the body member of the first and/or second ear hook. The microphone boom may have a first microphone mounted on the microphone boom, e.g. at the second end of the microphone boom.

The first microphone may be intended to capture the voice of a user wearing the microphone system. The microphone may be initially positioned to optimally capture the voice of the user. The microphone system and/or the microphone boom may be designed to maintain the initial position of the microphone relative to the mouth of the user, regardless of the head movement of the user. The first microphone may be phantom powered. The first microphone may be phantom powered using 12 volt, 24 volt, and/or 48 volt phantom powering.

The microphone boom may be partly flexible and allowing slight bending in a plastic deformation. Thereby positioning of the microphone is allowed in relation to the mouth of the user, and the microphone boom is allowed to follow the individual curvature of the head of the user. However, the microphone boom should be substantially rigid so that once positioned, the microphone maintains its position while the microphone system is worn.

The microphone boom may have a length from the first end to the second end in the range of 2-12 cm, or in the range of 4-10 cm, or in the range of 6-8 cm. The thickness of the microphone boom may be in the range of 0.5-5 mm, or in the range of 1-4 mm or in the range of 1-3 mm.

The microphone boom may be twistable around a longitudinal axis of the microphone boom. Being able to twist the microphone boom enables adjustment of the microphone and microphone boom. In particular, by twisting the microphone boom, the microphone and microphone boom may be adjusted to fit both a right and left side of a user.

The first microphone may be connected to a first conductor. The first microphone may be configured for receiving a first acoustic audio signal and converting the first acoustic audio signal to a first electrical audio signal. The audio signal may be transmitted through an electrical cable to an auxiliary device, which in many situations will contain means to transmit the audio signal wirelessly to a receiver. In most situations the auxiliary device will be located out of sight or be disguised if possible.

The microphone boom may comprise an electrical connector for connecting the first conductor to the first and/or second ear hook, or to the microphone connector on the body member of the first and/or second ear hook. The microphone boom may comprise a conductive tube, e.g. serving as ground conductor, wherein the first conductor is accommodated in a channel of the tube. The microphone boom may be removably attached to the body member. Thereby the microphone boom and the microphone may be easily removed or exchanged if needed. The microphone boom being removable may further allow the microphone to be easily relocated to the opposite side of the user's head, e.g. from the first ear hook to the second ear hook.

The microphone system comprises a first loudspeaker. The first loudspeaker may be connected to a second conductor. The first loudspeaker may be configured for converting a second electrical audio signal into a second acoustic audio signal. The microphone system may be configured to feed the second acoustic audio signal from the first loudspeaker via the output member of the ear hook.

A part of the output member may be placed in the ear canal of the user. The output member may be shaped such that it does not block the ear canal, such that the user is not prevented from perceiving surrounding sounds, e.g. voices or music. Alternatively the output member may be shaped to block the ear canal, such that the user is not subjected to surrounding sounds and/or noise.

The user wearing the microphone system may receive audio (cues, messages, music etc.) in the ear from the first loudspeaker. The user may receive the audio from the first loudspeaker via the output member of the microphone system.

The first loudspeaker may be arranged in the output member. The first loudspeaker may thus provide audible information directly into the ear of the user.

The output member may comprise an acoustic tube for directing an acoustic output signal from the first loudspeaker to the ear of a user. The first loudspeaker may thus be placed outside the ear canal, while the output member, comprising an acoustic tube, directs the acoustic output signal from the first loudspeaker to the ear of the user. The first loudspeaker may e.g. be placed in the body member of the ear hook, while the acoustic tube may be integrated within or along the hook part of the ear hook.

Any electrical wiring or acoustic tube for the earpiece is thereby disguised in an existing structure of the ear hook. Thus, an earpiece can be provided without additional unsightly electrical cables or tubes. Further, fitting the earpiece is easy once the microphone system is mounted on the ear of the user.

Additionally electrical wiring or acoustic tube is guided by the hook part of the ear hook around the pinna of the user's ear. Thus, the electrical wiring or acoustic tube is prevented from being dislocated from its hidden placement.

The microphone system may comprise a first electrical connector for connecting the microphone system to an auxiliary device, e.g. a first auxiliary device. The first electrical connector may be attached to the body member of the ear hook. The first electrical connector may comprise one or a plurality of terminals including a first terminal connected to the first conductor. The first conductor may be connected to the first microphone.

The first electrical connector may further comprise a second terminal connected to the second conductor. The second conductor may be connected to the first loudspeaker. By this exemplary electrical connector, the first electrical connector may connect both the first microphone and the first loudspeaker to a single auxiliary devices via a single electrical connector, i.e. the first electrical connector. A single electrical connector comprising both the first and second terminals provide for a more user friendly device, where only one electrical connector needs to be connected.

The microphone system may comprise a second electrical connector. The second electrical connector may comprise one or a plurality of terminals, such as the second terminal connected to the second conductor. In an examplary microphone system, the first electrical connector connects the first microphone to a first auxiliary device, while the second electrical connector connects the first loudspeaker to a second auxiliary device. The first microphone may, via the first electrical connector, be connected to a first auxiliary device, while the first loudspeaker, via the second electrical connector, may be connected to a second auxiliary device.

The first and/or second electrical connector may be attached to or be integrated in the body member of the first ear hook.

The first ear hook or the second ear hook may comprise the first electrical connector and/or the second electrical connector.

The microphone system may comprise one or more electrical cables, including a first electrical cable and/or a second electrical cable. The first and/or second electrical cable may each comprise an insulating jacket and at least a part of one or more cable conductors. The first electrical cable may be connected or removably connected to the first and/or second electrical connector. The first electrical cable may be connected or removably connected to the first and/or second electrical connector at a first end of the first electrical cable.

The first electrical cable may have a length of at least 20 cm or less than 160 cm, such as in the range of 20-160 cm or in the range of 40-140 cm, or in the range of 60-120 cm, or in the range of 80-100 cm.

The one or more electrical cables, e.g. the first and/or second electrical cable may be a split electrical cable having a first primary end and first secondary end. The first primary end may be connected or removably connected to the first electrical connector, and the first secondary end may be connected or removably connected to the second electrical connector.

The one or more electrical cables, e.g. the first and/or second electrical cable, may comprise a connector at a second end. The connector at a second end of the one or more electrical cables may be such as a jack connector, mini-jack connector, micro-dot connector, phono connector, DIN connector, BNC connector or similar.

The one or more electrical cables, e.g. the first and/or second electrical cable may be a split electrical cable, having a second primary end and second secondary end.

It may be beneficial to provide the microphone system with a single electrical cable that connects both microphone and loudspeaker(s) in a single connector. However, it may on the other hand be beneficial to provide the microphone system with separate electrical connectors, one for microphone and one for loudspeaker, to allow utilizing conventional equipment. Connecting the microphone system to conventional equipment may be achieved by utilizing a split electrical cable or a plurality of electrical cables.

The microphone system may comprise a second ear hook. A second ear hook may improve stability of the microphone system when worn by a user.

The second ear hook may comprise a body member, and a hook part. The hook part of the second ear hook may comprise a leaf spring for attaching the second ear hook to a second ear of the user.

The second ear hook may possess all or part of the same features as the first ear hook. In an exemplary microphone system the second ear hook may be identical to the first ear hook.

The microphone system may comprise a neck assembly. The first and the second ear hook may be mounted on the neck assembly. The neck assembly may provide guidance of the first and/or second conductors. The neck assembly may provide guidance of the one or more electrical cables.

By combining the use of two ear hooks connected with a neck assembly, the one or more electrical cables may be directed to the back of the user's head, and the microphone system may be more firmly attached to the user.

The neck assembly may comprise the first electrical connector and/or the second electrical connector. Hence, the electrical connectors can be placed behind the user, and out of sight.

The neck assembly may comprise a leaf spring. By utilizing a leaf spring in the neck assembly, the microphone system may achieve a fit that will suit a large majority of users. Further, the neck assembly may, by utilizing a structure such as a leaf spring, provide stability of the worn microphone system.

The neck assembly may comprise a conductor for conducting an electrical signal between the first ear hook and the second ear hook. This may be beneficial to allow for a single connector, i.e. the first electrical connector, to be electrically connected with the microphone and loudspeaker attached to opposite ear hooks.

The microphone boom may be attached to or removably attached to the body member of the first or second ear hook.

It may be beneficial to attach the microphone and the first loudspeaker opposite each other, such as attaching the microphone boom to the second ear hook and the first ear hook comprising the first loudspeaker. By placing the microphone opposite the first loudspeaker, the risk of the microphone capturing parts of the output signal from the first loudspeaker is greatly reduced, i.e. reduced feedback noise. Thereby a higher quality sound recording may be achieved.

The microphone system may comprise a second loudspeaker connected to a third conductor for converting a third electrical audio signal into a third acoustic audio signal. The microphone system may be configured to feed the third acoustic audio signal from the second loudspeaker via an output member of the second ear hook.

By utilizing two output members, the user may be able to receive audible signal in both ears. By utilizing two loudspeakers the user may be able to receive a stereo signal. Further, a two-loudspeaker microphone system may enable different types of information being sent to different ears, thus enabling a user to further separate and distinguish between different types of information.

The electrical connector(s), such as the first connector and/or the second connector, optionally comprises a ground terminal.

The first electrical connector, as described above, may further comprise a third terminal connected to the third conductor. By this, the first electrical connector connects both the first microphone and the first and the second loudspeaker using the same electrical connector.

In another exemplary microphone system, the second electrical connector comprises the second and the third terminal, wherein the second terminal is connected to the second conductor and the first loudspeaker, and wherein the third terminal is connected to the third conductor and the second loudspeaker.

In another exemplary microphone system, the microphone system comprises a third electrical connector. The third electrical connector may comprise the third terminal, wherein the third terminal is connected to the third conductor and the second loudspeaker.

In an exemplary microphone system, the second terminal may connect to the second conductor and the third conductor. By splitting the signal from one terminal to the second and third conductor, the same audio signal may be directed to both ears of the user. In an exemplary microphone system, this implementation may further ease the possibility of changing which ear the user should receive audible information via any of the loudspeakers.

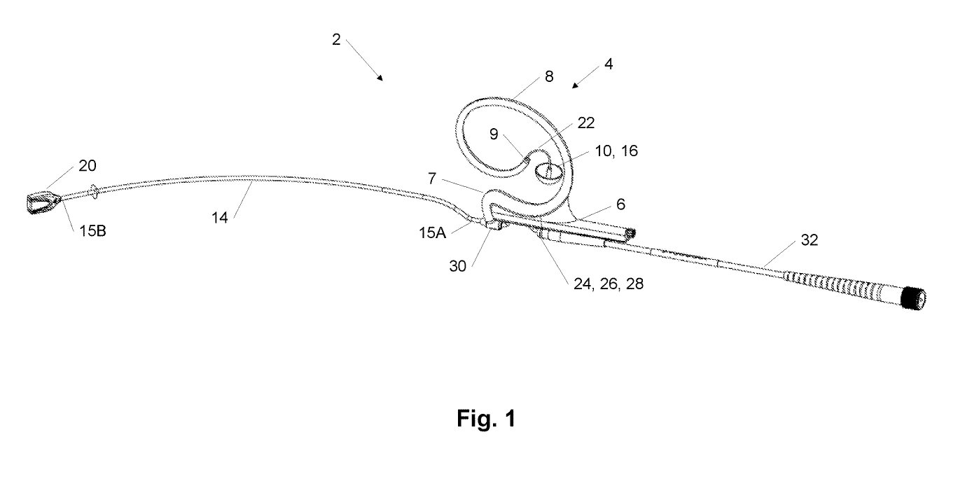

FIG. 1 illustrates an exemplary microphone system 2. The microphone system 2 comprises a first ear hook 4, a microphone boom 14, a microphone 20, a first loudspeaker 16, a first electrical connector 24, and a first electrical cable 32.

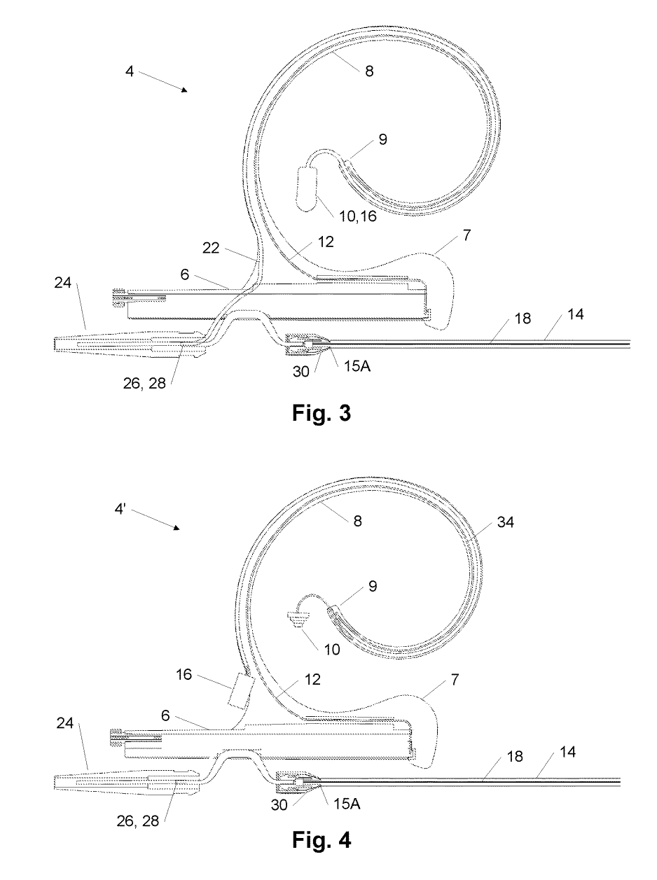

The first ear hook 4 comprises a body member 6, a hook part 8, and an output member 10. The hook part 8 has a first end 7 and a second end 9 with the first end 7 attached to the body member 6 and the second end 9 attached to the output member 10. The hook part further comprises flexible means 12 (FIG. 3) for affixing the ear hook 4 to a first ear of a user (not shown).

The body member 6 is adapted to abut a point behind the ear of the user, and the hook part 8 is configured to curl around the pinna, i.e. the outer ear of the user, and applying a gentle pressure that will fix the body member to the point behind the ear of the user. When worn, the second end 9 of the hook part 8 will be located at the top entrance of the user's ear.

The microphone 20 is connected to a first conductor 18 (FIG. 3) and mounted on the microphone boom 14. The microphone 20 is configured to receive a first acoustic audio signal and converting the first acoustic audio signal to a first electrical audio signal. The first acoustic audio signal mainly or at least partly comprises the user's voice.

The microphone boom 14 has a first end 15A and a second end 15B. The first end 15A of the microphone boom 14 is connected to the body member 6 of the ear hook 4. The microphone boom 14 is connected to the body member 6 by a microphone connector 30. In this depicted example, the microphone boom 14 may be removed from the body member 6 due to the microphone connector 30. The microphone 20 is mounted on the microphone boom 14 at the second end 15B.

The first loudspeaker 16 is connected to a second conductor 22 for converting a second electrical audio signal into a second acoustic audio signal. The microphone system 2 is configured to feed the second acoustic audio signal from the first loudspeaker 16 via the output member 10.

The first electrical connector 24 is for connecting the first electrical cable 32. The first electrical cable 32 connects the microphone system 2 to an auxiliary device (not shown). The electrical connector 24 comprises a first terminal 26, and the first terminal 26 is connected to the first conductor 18 (FIG. 3). Further, the electrical connector 24 comprises a second terminal 28 connected to the second conductor 22.

The microphone boom 14 comprise a microphone connector 30. The microphone connector 30 connects the first conductor 18 (FIG. 3) to the first terminal 26.

FIG. 3 schematically illustrates a cross section of an exemplary ear hook 4 with an output member 10, wherein the first loudspeaker 16 is located within the output member 10. The first loudspeaker 16 and the output member 10 are located near the second end 9 of the hook part 8. When worn, the first loudspeaker 16 is thus placed in the ear canal of the user.

Flexible means 12, such as a leaf spring, is provided inside the hook part 8 of the ear hook 4. The body member 6 is adapted to abut a bottom part behind the ear of the user, and the flexible means 12 is configured to apply a gentle pressure around the ear of the user. Thus, the position of the ear hook 4 is maintained by the hook member and the body member, and thus the position of the microphone 20 in respect to the mouth of the user is maintained.

The ear hook 4 comprises the first electrical connector 24. An electrical cable (FIG. 1) may attach the first electrical connector 24 to an auxiliary device (not shown). The first electrical connector 24 comprises the first terminal 26 electrically connected to the first conductor 18 and the second terminal 28 electrically connected to the second conductor 22.

The microphone boom 14 comprises the first conductor 18, that transmits the first electrical audio signal from the microphone 20 (e.g. FIG. 1) via the first electrical connector 24 to an auxiliary device (not shown). The ear hook 4 may comprise a microphone connector 30 that is configured to connect microphone boom 14 and the first conductor 18 to the ear hook 4 and electrically connect the first conductor 18 to the first terminal 26 of first electrical connector 24.

The second electrical conductor 22, transmits a second electrical audio signal from an auxiliary device (not shown) via the first electrical connector 24 to the first loudspeaker 16. The first loudspeaker 16 converts the second electrical audio signal into a second acoustic audio signal. The second acoustic audio signal is then fed to the user's ear via the output member 10.

FIG. 4 schematically illustrates a cross section of an exemplary ear hook 4′ with an acoustic tube 34. The first loudspeaker 16 is placed away from the second end 9 of the hook part 8, e.g. on the body member 6. The acoustic tube 34 is provided within the hook part 8, and the acoustic tube 34 is adapted to acoustically transmit sound from the first loudspeaker 16 to the output member 10. Thus, the user will hear the output of the first loudspeaker 16 via the output member 10, when the output member 10 is placed in the ear of the user.

The acoustic tube 34 is guided around the pinna of the user's ear, by the flexible means 12 of the hook part 8. Thus, transmission of sound to the user's ear is obtained in a very discrete way.

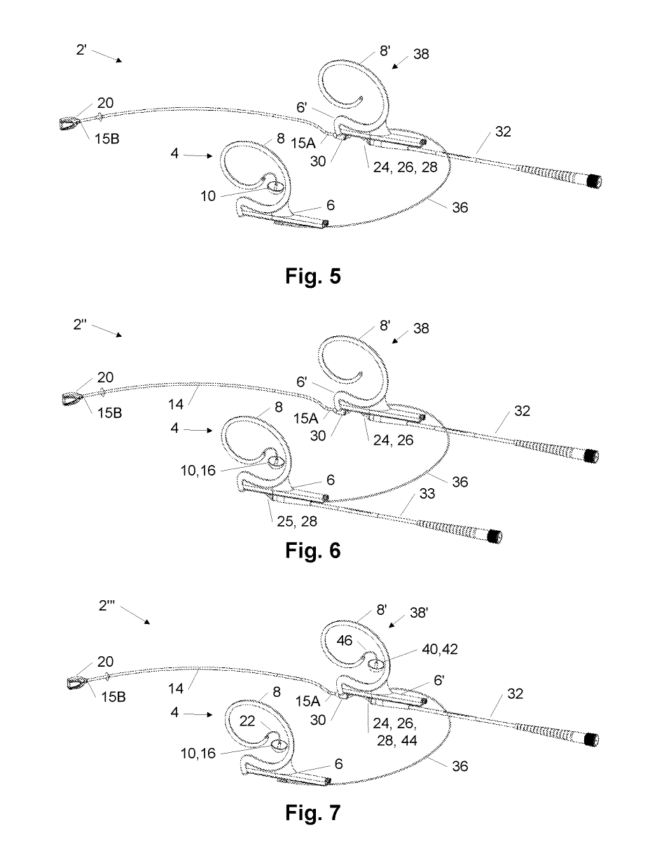

FIG. 5 illustrates an exemplary microphone system 2′ with a first ear hook 4 and a second ear hook 38. The microphone system 2′ comprises a neck assembly 36. The first ear hook 4 and the second ear hook 38 is mounted on the neck assembly 36. The microphone boom 14 is connected to the second ear hook 38 via the microphone connector 30. Generally the second ear hook 38 may comprise the same features as the first ear hook 4. The second ear hook 38 as depicted in FIG. 5 comprises a body member 6′ and a hook part 8′. The body member 6′ and the hook part 8′ are similar to the body member 6 and the hook part 8 of the first ear hook 4.

The first ear hook 4 comprises the output member 10, and the microphone boom 14 is attached to the body member 6′ of the second ear hook 38. The microphone boom 14 and the output member 10 may be attached to opposite ear hooks 4, 38, to reduce feedback of sound between the output member 10 and the microphone 20.

FIG. 6 illustrates an exemplary microphone system 2″ with a first ear hook 4 and a second ear hook 38. The first ear hook 4 comprises the first loudspeaker 16, and the microphone 20 is connected to the second ear hook 38. The microphone system 2″ is shown with a first electrical cable 32 connected to the first electrical connector 24, and a second electrical cable 33 connected to the second electrical connector 25.

The first electrical cable 32 is connected to the first electrical connector 24, and the first electrical connector 24 comprises the first terminal 26. The first terminal 26 is connected to the microphone via the first conductor 18 (FIG. 3).

The second electrical cable 33 is connected to the second electrical connector 25, and the second electrical 25 connector comprises the second terminal 28. The second terminal 28 is connected to the first loudspeaker 16 via the second conductor 22 (FIG. 3).

FIG. 7 illustrates an exemplary microphone system 2″' with a first ear hook 4 and a second ear hook 38′. The second ear hook 38′ comprises the same features as the first ear hook 4. The second ear hook 38′ comprises a body member 6′, a hook part 8′ and a second output member 40. The microphone boom 14 is connected to the second ear hook 38′. The second output member 40 comprises a second loudspeaker 42. The second loudspeaker may be configured for converting a third electrical audio signal into a third acoustic audio signal.

The exemplary microphone system 2′” depicted in FIG. 7 comprises two output members 10, 40, one in each of the ear hooks 4, 38′. Two output members 10, 40 allows for presentation of a stereo sound signal. A third terminal 44 may thus be applied to the first electrical connector 24, wherein the third terminal 44 is configured to connect to a third conductor 46, and the third conductor 46 is connected to the second loudspeaker 42.

In an alternative exemplary microphone system (not illustrated) similar to the exemplary microphone system 2′″, a second electrical connector may comprise the second and third terminal.

In general, all features of the illustrated exemplary microphone systems may be combined and interchanged individually.

### LIST OF REFERENCES

2, 2′,2″,2′″ microphone system
4 first ear hook
6, 6′ body member
7 first end of hook part
8, 8′ hook part
9 second end of hook part
10 first output member
12 flexible means
14 microphone boom
15A first end of microphone boom
15B second end of microphone boom
16 first loudspeaker
18 first conductor
20 microphone
22 second conductor
24 first electrical connector
25 second electrical connector
26 first terminal
28 second terminal
30 microphone connector
32 first electrical cable
33 second electrical cable
34 acoustic tube
36 neck assembly
38, 38′ second ear hook
40 second output member
42 second loudspeaker
44 third terminal
46 third conductor

1. A microphone system comprising:
a first ear hook comprising a body member, a hook part and an output member, the output member being configured to be positioned in the ear canal of a user, the hook part having a first end and a second end with the first end attached to the body member and the second end attached to the output member, the hook part comprising a leaf spring for affixing the ear hook to a first ear of the user,
a microphone boom having a first end and a second end, wherein the first end of the microphone boom is positioned below an ear of the user during use,
a first microphone connected to a first conductor and mounted on the microphone boom for receiving a first acoustic audio signal and converting the first acoustic audio signal to a first electrical audio signal,
a first loudspeaker connected to a second conductor for converting a second electrical audio signal into a second acoustic audio signal, wherein the microphone system is configured to feed the second acoustic audio signal from the first loudspeaker via the output member, and
at least one electrical connector for connecting the microphone system to an auxiliary device, the at least one electrical connector including a first electrical connector comprising a first terminal connected to the first conductor and the at least one electrical connector comprising a second terminal connected to the second conductor.

2. Microphone system according to claim 1, wherein the second terminal is arranged in the first electrical connector.

3. Microphone system according to claim 1, wherein the second terminal is arranged in a second electrical connector.

4. Microphone system according to claim 1, the microphone system comprising a first electrical cable connected or removably connected to the first electrical connector at a first end of the first electrical cable, the first electrical cable having a length of at least 20 cm.

5. Microphone system according to claim 4, wherein the first electrical cable is a split electrical cable, and the first electrical cable is connected or removably connected to the first electrical connector at a first primary end and the second electrical connector is connected or removably connected to a first secondary end.

6. Microphone system according to claim 1, wherein the first loudspeaker is arranged in the output member.

7. Microphone system according to claim 1, wherein the first loudspeaker is arranged in the body member and the hook part comprises a tube for directing the acoustic output signal from the loudspeaker to the ear of a user.

8. Microphone system according to claim 1, the microphone system comprising a second ear hook comprising a body member, and a hook part, the hook part of the second ear hook comprising a leaf spring for attaching the second ear hook to a second ear of the user, wherein the microphone system comprises a neck assembly with the first and the second ear hook mounted on the neck assembly.

9. Microphone system according to claim 1, wherein the microphone boom is removably attached to the body member of the first ear hook.

10. Microphone system according to claim 8, wherein the microphone boom is removably attached to the body member of the second ear hook.

11. Microphone system according to claim 1, wherein the second ear hook comprises an output member, and the microphone system comprises a second loudspeaker connected to a third conductor for converting a third electrical audio signal into a third acoustic audio signal, wherein the microphone system is configured to feed the third acoustic audio signal from the second loudspeaker via the output member of the second ear hook.

12. Microphone system according to claim 1, wherein the first ear hook comprises the first electrical connector.

13. Microphone system according to claim 1, wherein the second ear hook comprises the first electrical connector.

14. Microphone system according to claim 1, wherein the first ear hook comprises the second electrical connector.

15. Microphone system according to claim 1, wherein the second ear hook comprises the second electrical connector.
